(19) United States
(12) Patent Application Publication
(10) Pub. No.: US 2025/0147307 A1
(43) Pub. Date: May 8, 2025

(54) HEAD-UP DISPLAY APPARATUS

(71) Applicant: HYUNDAI MOBIS CO., LTD., Seoul (KR)

(72) Inventors: Byung Ki KIM, Yongin-si (KR); Yu Jin SHIN, Seongnam-si (KR)

(73) Assignee: HYUNDAI MOBIS CO., LTD., Seoul (KR)

(21) Appl. No.: 18/883,244

(22) Filed: Sep. 12, 2024

(30) Foreign Application Priority Data
Nov. 7, 2023 (KR) 10-2023-0152499

(51) Int. Cl. G02B 27/01

(52) U.S. Cl. CPC G02B 27/0101; G02B 27/0149

(57) ABSTRACT

A head-up display apparatus and a head-up display for a vehicle are provided. The head-up display includes a lower case disposed at a lower portion of the head-up display apparatus, a screen coupled to the lower case and configured to include a light path formed therein, and a picture generator coupled to a side wall or a bottom portion of the lower case. The picture generator includes a backlight configured to generate light, a diffuser uniformly to disperse light generated from the backlight, and a liquid crystal layer to selectively transmit light based on a magnitude of voltage applied thereto. When the head-up-display apparatus is configured to include one mirror, the picture generator is coupled to the side wall of the lower case, and when the head-up-display apparatus is configured to include at least two mirrors, the picture generator is coupled to the bottom portion of the lower case.

### CROSS-REFERENCE TO RELATED APPLICATION(S)

This application claims priority to and benefit under 35 USC § 119 of Korean Patent Application No. 10-2023-0152499 filed on Nov. 7, 2023, in the Korean Intellectual Property Office, the entire disclosure of which is incorporated herein by reference for all purposes.

### BACKGROUND

### 1. Field

The present disclosure relates to a head-up display apparatus.

### 2. Description of the Related Art

The content described in this section merely provides background information related to one embodiment of the present disclosure and does not constitute prior art.

Conventional head-up displays include one mirror type and two mirror type. The one-mirror type head-up display has a light path from a picture forming unit to an aspherical mirror, a windshield, and driver's field of view.

In the two-mirror type head-up display, a folding mirror is additionally formed between the picture generating unit and the aspherical mirror. Accordingly, the optical paths between the one-mirror type head-up display and the two-mirror type head-up display are different, and there is a problem in that an optical unit, for example, the picture generating unit, cannot be shared.

Therefore, the optical units of the one-mirror type head-up display and the two-mirror type head-up display, for example, heat sinks and mounts of the picture generating units, need to be manufactured separately, resulting in an increase in manufacturing costs.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In a general aspect of the disclosure, a head-up display apparatus includes: a lower case disposed at a lower portion of the head-up display apparatus; a screen coupled to the lower case and configured to include a light path formed therein; and a picture generator coupled to a side wall or a bottom portion of the lower case, wherein the picture generator includes: a backlight configured to generate light; a diffuser uniformly to disperse light generated from the backlight; and a liquid crystal layer configured to selectively transmit light based on a magnitude of voltage applied thereto, wherein, when the head-up-display apparatus is configured to include one mirror, the picture generator is coupled to the side wall of the lower case, and wherein, when the head-up-display apparatus is configured to include at least two mirrors, the picture generator is coupled to the bottom portion of the lower case.

The backlight may include: a light emitting diode printed circuit board (LED PCB) including a plurality of light sources; a funnel reflector configured to concentrate light emitted from the LED PCB toward the liquid crystal layer; and a heat sink including an accommodation portion accommodating the funnel reflector and the LED PCB, and a flange portion coupled to the lower case.

The screen may include a liquid crystal layer mounting portion on which the liquid crystal layer is mounted, and the liquid crystal layer mounting portion may be formed based on a predetermined angle formed on the side wall or bottom portion of the lower case.

The lower case may include a liquid crystal layer mounting portion on which the liquid crystal layer is mounted, and the liquid crystal layer mounting portion may be formed based on a predetermined angle formed on the side wall or bottom portion of the lower case.

The flange portion may have a symmetrical shape.

The flange portion may include: at least one first locator configured to form a surface protruded by a predetermined height in a z-axis direction on the flange portion and constrain linear movement of the picture generating unit in at least one direction; a second locator configured to constrain linear movement of the picture generating unit in at least four directions; and a third locator configured to constrain linear movement of the picture generating unit in at least two directions.

The liquid crystal layer may be configured to mount on the liquid crystal layer mounting portion by: snap-fitting the liquid crystal layer to the liquid crystal layer mounting portion; and snap-fitting the diffuser to the liquid crystal layer mounting portion; and fixing between the diffuser and the liquid crystal layer using an adhesive.

The liquid crystal layer may be configured to mount on the liquid crystal layer mounting portion by: fixing between the diffuser and the liquid crystal layer using an adhesive; and snap-fitting the diffuser and the liquid crystal layer to the liquid crystal layer mounting portion.

The liquid crystal layer may be configured to mount on the liquid crystal layer mounting portion by: snap-fitting the liquid crystal layer to the liquid crystal layer mounting portion; snap-fitting the diffuser to the liquid crystal layer mounting portion; and fixing the liquid crystal layer and the diffuser to the liquid crystal layer mounting portion using at least one fixing component configured to penetrate at least a portion of the liquid crystal layer, the diffuser, and the liquid crystal layer mounting portion.

The liquid crystal layer may be configured to mount on the liquid crystal layer mounting portion by: snap-fitting the liquid crystal layer to the liquid crystal layer mounting portion; snap-fitting the diffuser to the liquid crystal layer mounting portion; and fixing the liquid crystal layer and the diffuser to the liquid crystal layer mounting portion using at least one fixing portion protruding from the liquid crystal layer mounting portion.

In another general aspect of the disclosure, a head-up display apparatus for a vehicle, includes: a lower case disposed at a lower portion of the head-up display apparatus; a screen coupled to the lower case and including a light path formed therein; a picture generator including a liquid crystal layer; a processor configured to control the liquid crystal layer to selectively transmit light, based on a magnitude of voltage applied to the liquid crystal layer, an aspherical mirror configured to reflect an image including driving information of the vehicle generated by the picture generator to be displayed on a windshield of the vehicle, wherein the head-up display is configured to accommodate a folding mirror disposed in the light path for modification of the head-up display to a two-mirror type head-up display, wherein, in case the head-up-display apparatus is configured to include one mirror, the picture generator is coupled to the side wall of the lower case, and wherein, in case the head-up-display apparatus is configured to include at least two mirrors, the picture generator is coupled to the bottom portion of the lower case.

The picture generator further may include: a backlight configured to generate light; and a diffuser uniformly to disperse light generated from the backlight.

The processor may be further configured to control movement of the folding mirror to a position where an image generated by the picture generator is reflected by the folding mirror and projected toward the aspherical mirror.

The problems to be solved by the present disclosure are not limited to the problems mentioned above, and other problems not mentioned can be clearly understood by those skilled in the art from the description below.

### BRIEF DESCRIPTION OF THE DRAWINGS

FIG. 1 is a perspective view showing the configuration of a one-mirror type head-up display according to one embodiment of the present disclosure.

FIGS. 2A and 2B are diagrams showing the coupled state of a picture generating unit mounted on the one-mirror type head-up display apparatus.

FIG. 3 is an exploded perspective view showing the configuration of the one-mirror type head-up display according to one embodiment of the present disclosure.

FIGS. 4A to 4D are exploded perspective views showing various examples of coupling methods between a liquid crystal layer and a diffuser of FIG. 3.

FIG. 5 is a perspective view showing the configuration of a two-mirror type head-up display according to another embodiment of the present disclosure.

FIGS. 6A and 6B are diagrams showing the coupled state of the picture generating unit mounted on the head-up display apparatus.

FIG. 7 is an exploded perspective view showing the configuration of the two-mirror type head-up display according to another embodiment of the present disclosure.

FIG. 8 is an exploded perspective view showing the picture generating unit of FIG. 7 in detail.

FIG. 9A is a left cross-sectional view taken along line A-A of FIG. 1.

FIG. 9B is a left cross-sectional view taken along line B-B in FIG. 5.

FIG. 10 is a plan view showing a backlight unit according to an embodiment of the present disclosure.

FIG. 11 is a plan view showing a backlight unit according to another embodiment of the present disclosure.

FIG. 12 is a diagram showing a structure to prevent incorrect assembly of a funnel reflector coupled to the one-mirror type head-up display and the two-mirror type head-up display.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The objects of the present disclosure are not limited to those particularly described hereinabove, and the above and other objects that the present disclosure can achieve will be clearly understood by those skilled in the art from the following detailed description.

Hereinafter, various exemplary embodiments of the present disclosure will be described in detail with reference to the accompanying drawings. In the following description, like reference numerals preferably designate like elements, although the elements are shown in different drawings. Furthermore, the following description of various exemplary embodiments will omit for the purpose of clarity and for brevity, a detailed description of related known components and functions when considered obscuring the subject of the present disclosure.

Various ordinal numbers or alpha codes such as first, second, i), ii), a), b), etc., are prefixed solely to differentiate one component from the other but not to imply or suggest the substances, order, or sequence of the components. Throughout the present specification, when a part “includes” or “comprises” a component, the part is meant to further include other components, to not exclude thereof unless specifically stated to the contrary.

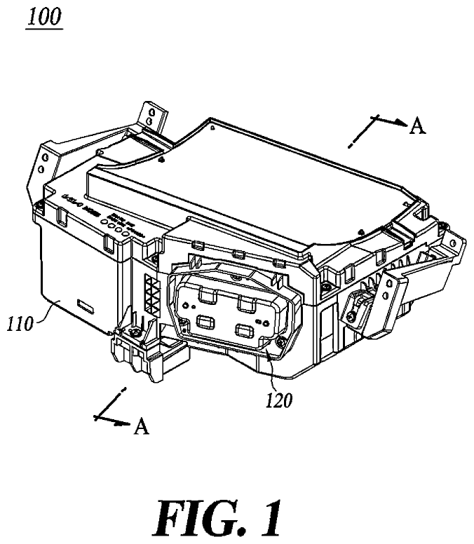

FIG. 1 is a perspective view showing the configuration of a one-mirror type head-up display according to one embodiment of the present disclosure.

Referring to FIG. 1, the one-mirror type head-up display apparatus 100 may include a lower case 110 and a picture generating unit 120. In this case, the picture generating unit 120 may be coupled to a side wall of the lower case 110.

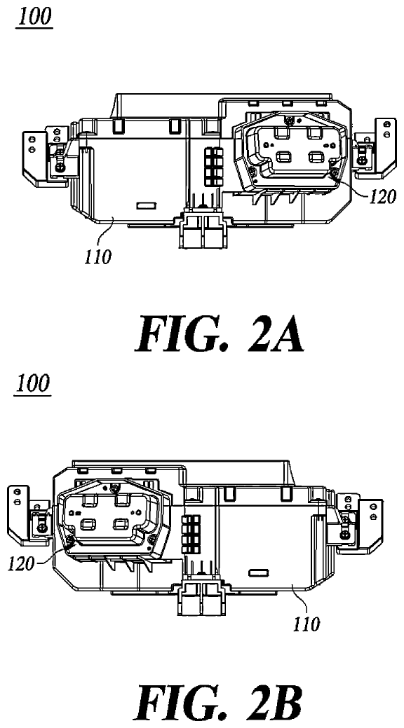

FIGS. 2A and 2B are diagrams showing the coupled state of the picture generating unit mounted on the one-mirror type head-up display apparatus. In detail, FIG. 2A is a diagram showing the coupled state of the picture generating unit when the one-mirror type head-up display according to one embodiment of the present disclosure is placed on the left side of a vehicle. FIG. 2B is a diagram showing the coupled state of the picture generating unit when the one-mirror type head-up display according to one embodiment of the present disclosure is placed on the right side of a vehicle.

Referring to FIGS. 2A and 2B, the one-mirror type head-up display apparatus 100 may be placed on the left or right side of the vehicle. In this case, the left side of the vehicle refers to the driver's seat, and the right side refers to the passenger seat. Accordingly, as the one-mirror type head-up display apparatus 100 is placed on the left or right side of the vehicle, the positions at which the picture generating unit 120 is coupled to the lower case 110 are different. The picture generating unit 120 according to one embodiment of the present disclosure is designed to be usable regardless of whether the one-mirror type head-up display apparatus 100 is placed on the left or right side of the vehicle.

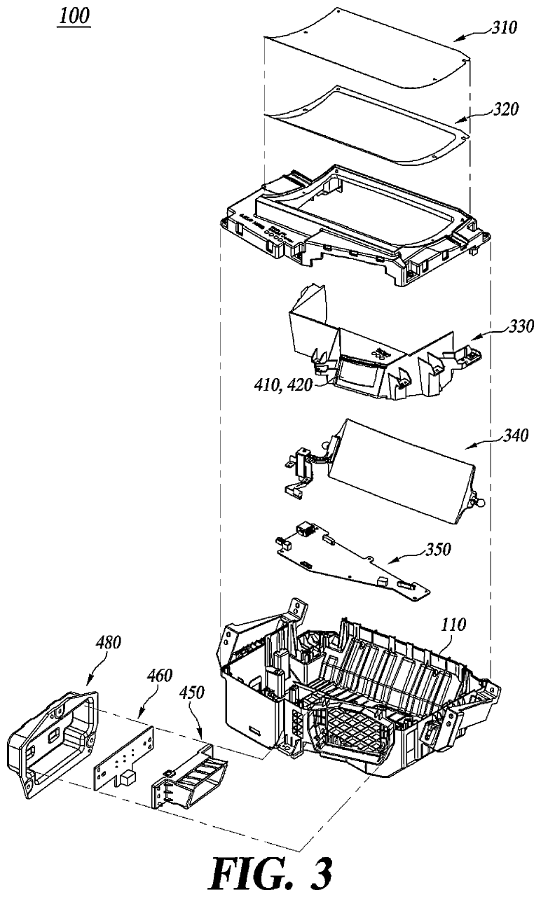

FIG. 3 is an exploded perspective view showing the configuration of the one-mirror type head-up display according to the embodiment of the present disclosure.

Referring to FIG. 3, the one-mirror type head-up display apparatus 100 includes some or all of a cover lens assembly 310, an upper case 320, a screen 330, an aspheric mirror 340, a main printed circuit board (PCB) 350, a lower case 110, and a picture generating unit 120. In this case, the picture generating unit 120 includes some or all of a liquid crystal layer 410, a diffuser 420, and a backlight unit 440.

The cover lens assembly 310 is coupled to the front of the upper case 320.

The screen 330 may be coupled to the top of the aspherical mirror 340. The screen 330 may be coupled to the lower case 110 to constrain at least one linear movement of the aspherical mirror 340. The screen 330 may be configured to have a light path formed therein.

The screen 330 includes a liquid crystal layer mounting portion 430 on which the liquid crystal layer 410 is mounted. The liquid crystal layer mounting portion 430 may be formed on one side of the screen 330. The liquid crystal layer mounting portion 430 may be formed based on an angle formed on a side wall or bottom portion of the lower case 110.

The aspherical mirror 340 may include spherical mounts (not shown) at both ends that are coupled to the lower case 110 to be rotatable. An image including driving information of the vehicle generated by the picture generating unit 120 may be reflected by the aspherical mirror 340 and displayed on a windshield (not shown).

The liquid crystal layer 410 may be configured to selectively transmit light depending on a voltage applied thereto. A processor or controller (not shown) may control the voltage applied thereto.

The diffuser 420 is disposed at the rear side of the liquid crystal layer 410. In this case, the rear side of the liquid crystal layer 410 refers to a side of the liquid crystal layer 410 that faces the backlight unit 440. The diffuser 420 disperses the light emitted from the backlight unit 440 so that the light is uniformly incident on the rear of the liquid crystal layer 410.

The backlight unit 440 includes a funnel reflector 450, a light emitting diode printed circuit board (LED PCB) 460, a thermal grease 470, and a heat sink 480.

The backlight unit 440 irradiates light generated from a plurality of light sources (not shown) disposed on the LED PCB 460 onto the liquid crystal layer 410.

The funnel reflector 450 may be placed at the front of the LED PCB 460 on which the light sources are disposed. The funnel reflector 450 may be disposed at the rear of the liquid crystal layer 410 and the diffuser 420. The funnel reflector 450 guides the path of light emitted from the light sources so that the light is uniformly incident on the diffuser 420 and the liquid crystal layer 410. The inside of the funnel reflector 450 may form a cup-shaped optical surface to guide the path of light emitted from the light sources.

The LED PCB 460 includes a plurality of light sources (not shown). In this case, the light source is a member that emits light. The light source may be an LED (Light Emitting Diode). A plurality of light sources may be arranged in a predetermined pattern on the LED PCB 460.

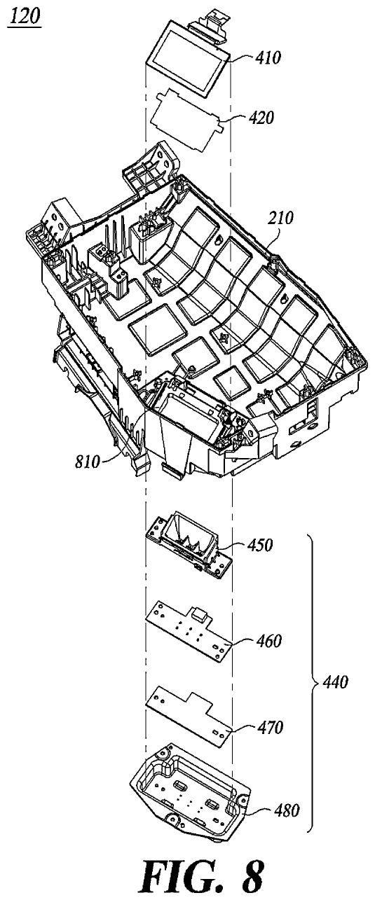

The thermal grease 470 is disposed at the rear of the LED PCB 460 as shown in FIG. 8. The thermal grease 470 may be a heat-resistant adhesive member.

The heat sink 480 dissipates heat generated inside the backlight unit 440. The heat sink 480 is coupled to the lower case 110 using bolts and nuts.

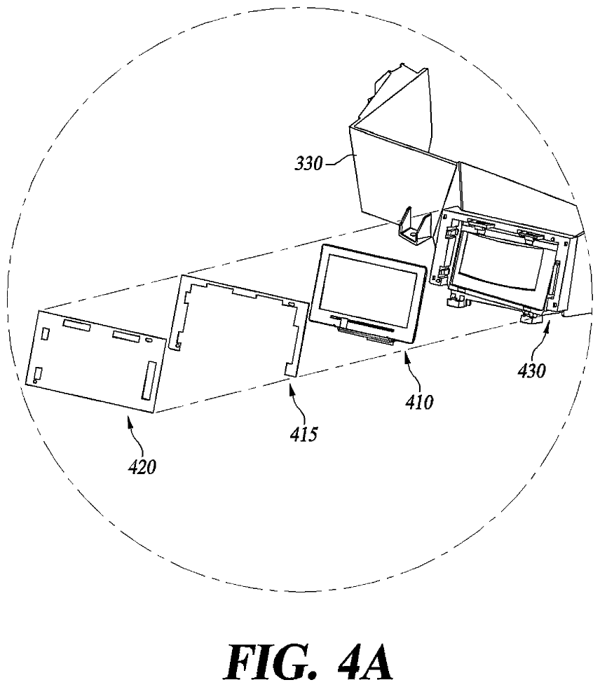

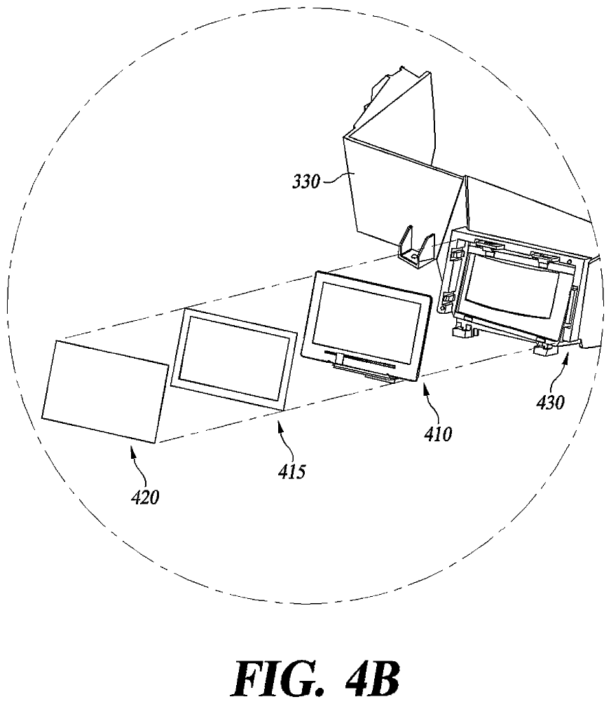

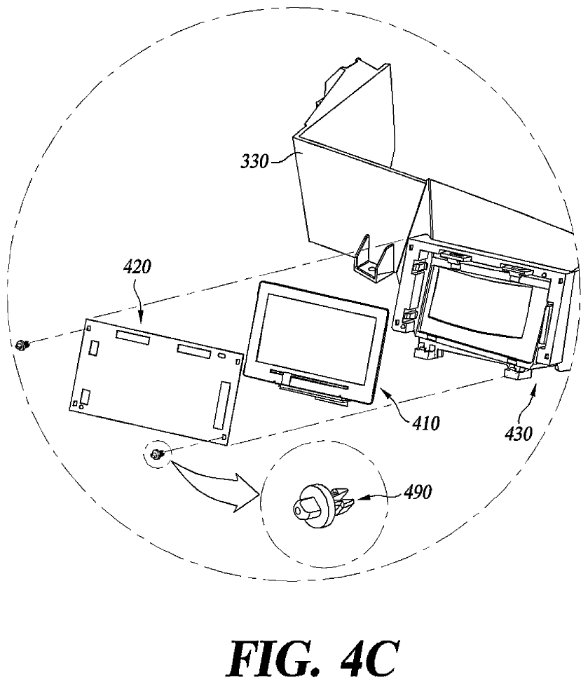

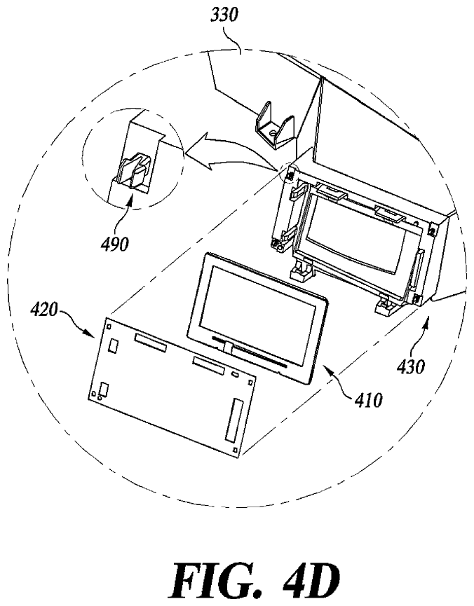

FIGS. 4A to 4D are exploded perspective views showing various examples of coupling methods between the liquid crystal layer 410 and the diffuser 420 of FIG. 3.

Referring to FIG. 4A, the liquid crystal layer 410 and the diffuser 420 of FIG. 3 according to one embodiment may be coupled to the screen 330 through the following process.

After the liquid crystal layer 410 is snap-fitted to the liquid crystal layer mounting portion 430, the diffuser 420 is snap-fitted to the liquid crystal layer mounting portion 430, and the diffuser 420 and the liquid crystal layers 410 are bonded to each other using an adhesive 415.

Referring to FIG. 4B, the liquid crystal layer 410 and the diffuser 420 of FIG. 3 according to another embodiment may be coupled to the screen 330 through the following process.

After fixing the diffuser 420 and the liquid crystal layer 410 using the adhesive 415, the diffuser 420 and the liquid crystal layer 410 are snap-fitted to the liquid crystal layer mounting portion 430.

Referring to FIG. 4C, the liquid crystal layer 410 and the diffuser 420 of FIG. 3 according to another embodiment may be coupled to the screen 330 through the following process.

The liquid crystal layer 410 is snap-fitted to the liquid crystal layer mounting portion 430, and the diffuser 420 is snap-fitted to the liquid crystal layer mounting portion 430. The liquid crystal layer 410 and the diffuser 420 are fixed to the liquid crystal layer mounting portion 430 using at least one fixing unit 490 that penetrates at least a portion of the liquid crystal layer 410, the diffuser 420, and the liquid crystal layer mounting portion 430.

Referring to FIG. 4D, the liquid crystal layer 410 and the diffuser 420 of FIG. 3 according to another embodiment may be coupled to the screen 330 through the following process.

The liquid crystal layer 410 is snap-fitted to the liquid crystal layer mounting portion 430, and the diffuser 420 is snap-fitted to the liquid crystal layer mounting portion 430. The liquid crystal layer 410 and the diffuser 420 are fixed to the liquid crystal layer mounting portion 430 using at least one fixing unit 490 protruding from the liquid crystal layer mounting portion 430.

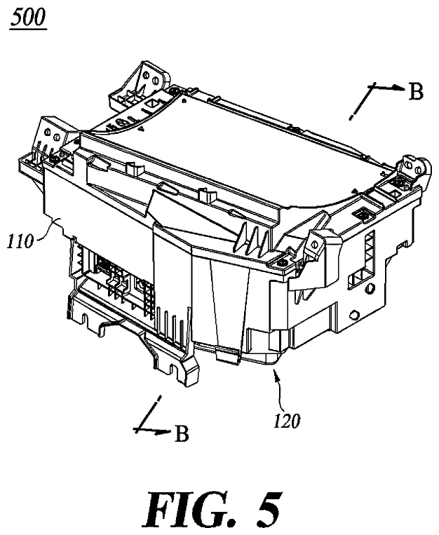

FIG. 5 is a perspective view showing the configuration of a two-mirror type head-up display according to another embodiment of the present disclosure.

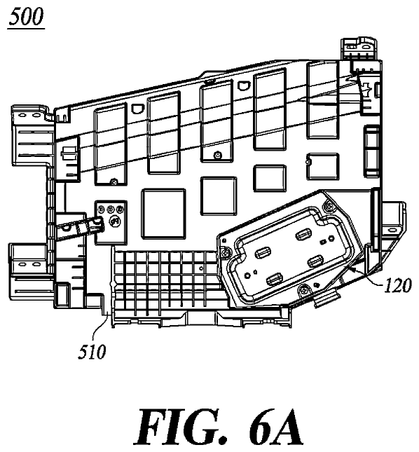

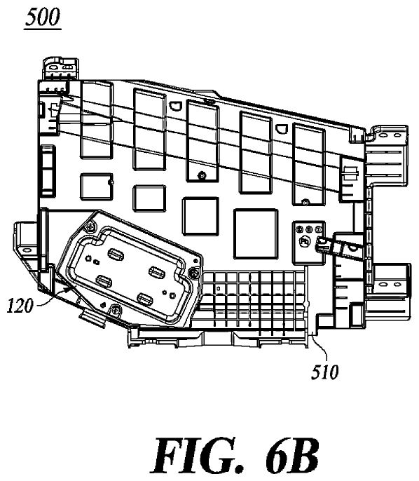

FIGS. 6A and 6B are diagrams showing the coupled state of the picture generating unit mounted on the two-mirror type head-up display apparatus. In detail, FIG. 6A is a diagram showing the coupled state of the picture generating unit when the two-mirror type head-up display according to another embodiment of the present disclosure is placed on the left side of a vehicle. FIG. 6B is a diagram showing the coupled state of the picture generating unit when the two-mirror type head-up display according to another embodiment of the present disclosure is placed on the right side of the vehicle.

Referring to FIGS. 5, 6A and 6B, the two-mirror type head-up display apparatus 500 includes a lower case 510 and a picture generating unit 120. In this case, the picture generating unit 120 may be coupled to the bottom portion of the lower case 510. The two-mirror type head-up display apparatus 500 may also be placed on the left or right side of the vehicle, like the one-mirror type head-up display apparatus 100. Accordingly, as the two-mirror type head-up display apparatus 500 is placed on the left or right side of the vehicle, the positions at which the picture generating unit 120 is coupled to the lower case 510 are different.

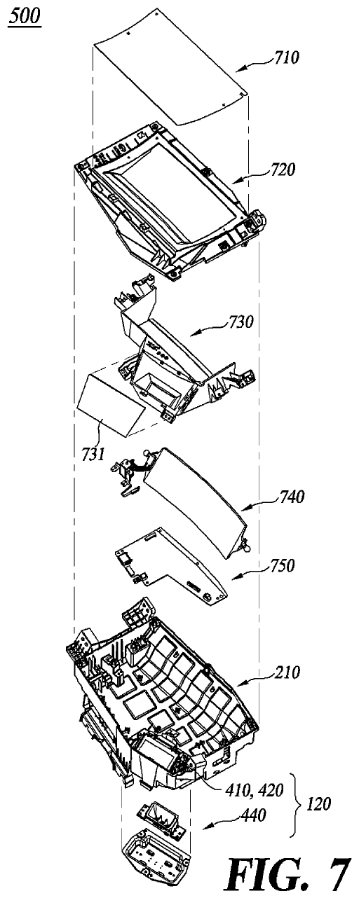

FIG. 7 is an exploded perspective view showing the configuration of the two-mirror type head-up display according to another embodiment of the present disclosure.

FIG. 8 is an exploded perspective view showing the picture generating unit of FIG. 7 in detail.

Hereinafter, in the description of the configuration of the two-mirror type head-up display apparatus 500, redundant description of the same configuration as that of the one-mirror type head-up display apparatus 100 described above will be omitted and the differences will be discussed.

Referring to FIGS. 7 and 8, the two-mirror type head-up display apparatus 500 includes some or all of a cover lens assembly 710, an upper case 720, a screen 730, an aspherical mirror 740, a main PCB 750, a lower case 510, and a picture generating unit 120.

The two-mirror type head-up display apparatus 500 further includes a folding mirror 731. The folding mirror 731 is disposed in a light path formed inside the screen 730. Thus, light generated from the LED PCB 750 is reflected by the folding mirror 731 via the liquid crystal layer 410. A processor or controller (not shown) may be included to control the movement of the folding mirror 731.

The lower case 510 includes a liquid crystal layer mounting portion 810 on which the liquid crystal layer 410 is mounted. The liquid crystal layer mounting portion 810 may be formed on one side of the lower case 510. Accordingly, the liquid crystal layer 410 and the diffuser 420 may be snap-fitted to the liquid crystal layer mounting portion 810 formed in the lower case 510. In addition, the backlight unit 440 may be coupled to the rear of the liquid crystal layer mounting portion 810. In this case, the front and rear are defined based on the path along which the light generated from the LED PCB 460 is irradiated toward the liquid crystal layer 410.

According to the present disclosure, the backlight unit 440 may be commonly coupled to both the one-mirror type head-up display apparatus 100 and the two-mirror type head-up display apparatus 500.

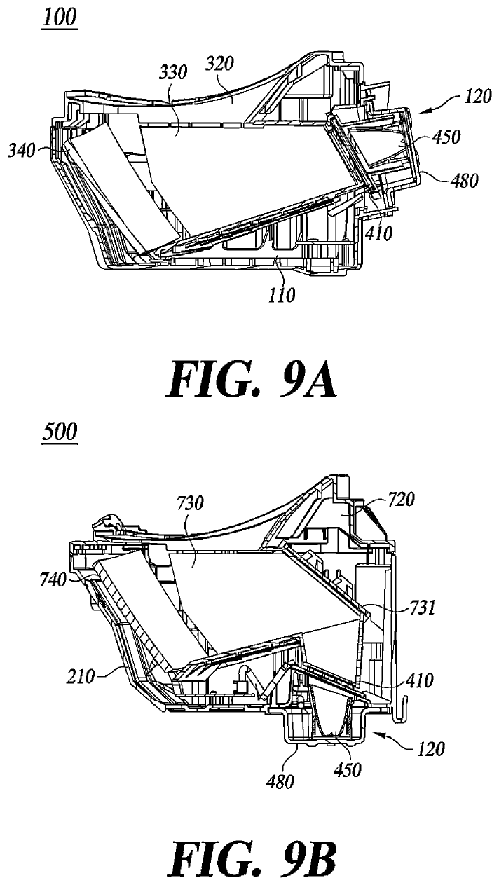

FIG. 9A is a left cross-sectional view taken along line A-A of FIG. 1.

FIG. 9B is a left cross-sectional view taken along line B-B in FIG. 5.

Referring to FIGS. 9A and 9B, the one-mirror type head-up display apparatus 100 includes one mirror therein. In this case, one mirror may be the aspherical mirror 340. Therefore, in the one-mirror type head-up display apparatus 100, it is preferable that the picture generating unit 120 is coupled to the side surface of the lower case 110. The liquid crystal layer 410 disposed at the same angle as the top surface of the funnel reflector 450 is tilted by a predetermined angle to project a display image to the aspherical mirror 340.

The two-mirror type head-up display apparatus 500 includes two mirrors therein. In this case, the two mirrors may be the folding mirror 731 and the aspherical mirror 740. In the two-mirror type head-up display apparatus 500, the picture generating unit 120 is coupled to the bottom portion of the lower case 510. The liquid crystal layer 410 disposed at the same angle as the top surface of the funnel reflector 450 is tilted by a predetermined angle to project a display image to the folding mirror 731. The display image may be reflected by the folding mirror 731 and projected toward the aspherical mirror 740. Accordingly, the angles of the liquid crystal layers 410 coupled to the one-mirror type head-up display apparatus 100 and the two-mirror type head-up display apparatus 500 are different from each other. The angle difference between the liquid crystal layers 410 coupled to the one-mirror type head-up display apparatus 100 and the two-mirror type head-up display apparatus 500 may be, for example, 180°. Thus, when the funnel reflector 450 is coupled to the heat sink 480 of the one-mirror type head-up display apparatus 100 in a normal direction, the funnel reflector 450 may be coupled to the heat sink 480 of the two-mirror type head-up display apparatus 500 by being rotated, for example, 180°. By coupling the funnel reflector 450 to the picture generating unit 120 in the normal or reverse direction, the backlight unit 440 can be commonly coupled to both the one-mirror type head-up display apparatus 100 and the two-mirror type head-up display apparatus 500.

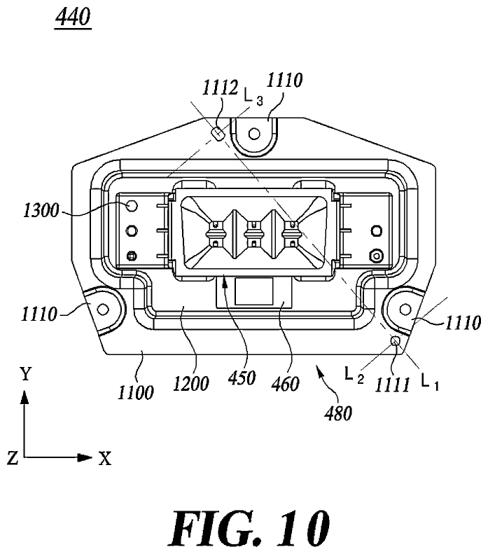

FIG. 10 is a plan view showing the backlight unit according to one embodiment of the present disclosure.

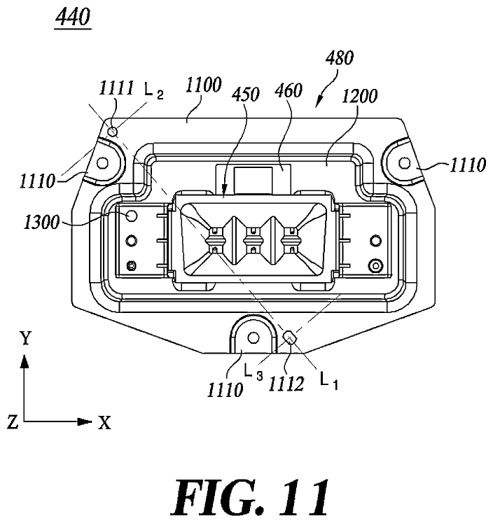

FIG. 11 is a plan view showing the backlight unit according to another embodiment of the present disclosure.

Referring FIGS. 10 and 11, the heat sink 480 is coupled to the bottom of the funnel reflector 450. The heat sink 480 includes a flange portion 1100 and an accommodation portion 1200.

The flange portion 1100 has a polygonal cross-sectional shape. For example, the flange portion 1100 may have eight corners. In addition, the flange portion 1100 has a symmetrical shape. For example, the flange portion 1100 may have a symmetrical structure in which the left and right sides have the same shape based on an imaginary center line perpendicular to the longitudinal direction.

The accommodation portion 1200 forms an accommodation space for accommodating the funnel reflector 450 and the LED PCB 460. The accommodation portion 1200 may accommodate the LED PCB 460 and the funnel reflector 450.

The flange portion 1100 may include a first locator 1110, a second locator 1111, and a third locator 1112. The heat sink 480 is coupled to a side wall or bottom of the lower cases 110 and 510. Thus, the first locator 1110, the second locator 1111, and the third locator 1112 may determine the position of the picture generating unit 120 and the backlight unit 440 by being engaged with blocks (not shown) formed in the lower cases 110 and 510. In this case, the first locator 1110 and the second locator 1111 may be holes.

Unlike a workpiece whose position is generally determined through six independent blocks, e.g., locators, the position of a sheet panel may be determined through a combination of blocks and pins. The first locator 1110, the second locator 1111 and the third locator 1112 form a 3-2-1 positioning. The second locator 1111 constrains movement in two orthogonal directions, e.g., four directions, and the third locator 1112 constrains movement in one orthogonal direction, e.g., two directions. Thus, the one-mirror type head-up display apparatus 100 and the two-mirror type head-up display apparatus 500, according to one embodiment and another embodiment of the present disclosure, may be coupled to a head-up display based on a 3-2-1 positioning method using the configuration of the first locator 1110, the second locator 1111, and the third locator 1112 when determining the position of the picture generating unit 120 and the backlight unit 440.

The number of first locators 1110 may be at least three. The first locator 1110 is formed at a central portion, and left and right portions of the flange portion 1100. In this case, at least one first locator 1110 is disposed at the central portion of the flange portion 1100, and two first locators 1110 are disposed on the flange portion 1100 symmetrically with respect to the at least one first locator 1100 disposed. The first locator 1100 forms a surface protruded by a predetermined height in a z-axis direction. The area of the protruding first locator 1100 may be an area capable of generating sufficient coupling force when the picture generating unit 120 and the backlight unit 440 are coupled to the lower cases 110 and 510. A hole is formed in the center of the first locator 1110. The hole formed in the first locator 1110 is engaged with a boss (not shown) formed in the lower cases 110 and 510. Accordingly, the first locator 1110 may constrain the linear movement of the picture generating unit 120 in at least one direction. For example, the first locator 1110 may constrain the linear movement of the picture generating unit 120 in the z-axis.

The position of the picture generating unit 120 may be determined using the first locator 1100, the second locator 1111, and the third locator 1112. The second locator 1111 may constrain the linear movement of the picture generating unit 120 in at least four directions. For example, in the picture generating unit 120 coupled to the one-mirror type head-up display apparatus 100 according to one embodiment of the present disclosure, the linear motion of the picture generating unit 120 in the x-axis, −x-axis, y-axis, and −y-axis directions can be constrained using the second locator 1111 formed on the liquid crystal layer mounting portion 430. The third locator 1112 formed on the liquid crystal layer mounting portion 430 constrains the linear movement of the picture generating unit 120 in at least two directions. For example, the third locator 1112 can constrain the linear movement of the picture generating unit 120 in the y-axis and −y-axis directions.

In addition, the picture generating unit 120 coupled to the one-mirror type head-up display apparatus 100 according to one embodiment of the present disclosure may determine its position using the second locator 1111 and the third locator 1112 formed on the flange portion 1100. When the position of the picture generating unit 120 is determined using the second locator 1111 and the third locator 1112 formed on the heat sink 480, the second locator 1111 formed on the heat sink 480 constrains the linear motion of the picture generating unit 120 corresponding to imaginary straight lines L1 and L2. Further, the third locator 1112 formed on the heat sink 480 constrains the linear motion of the picture generating unit 120 corresponding to an imaginary straight line L3.

Based on the foregoing, when the liquid crystal layer mounting portion 810 is formed on the lower case 510, the backlight unit 440 is coupled to the rear of the liquid crystal layer mounting portion 810. Of the backlight unit 440, the heat sink 480 may be coupled to the lower case 510. In this case, the position of the backlight unit 440 is determined using the first locator 1110, the third locator 1111, and the second locator 1112 formed on the heat sink 480, and the linear motion of the backlight unit 440 in, e.g., six directions may be constrained.

The backlight unit 440, according to another embodiment of the present disclosure, may vary the angle of the picture generating unit 120 by varying the position of the second locator 1111 and the third locator 1112. Thus, the angle of the picture generating unit 120 can be varied to be applied to various vehicle types.

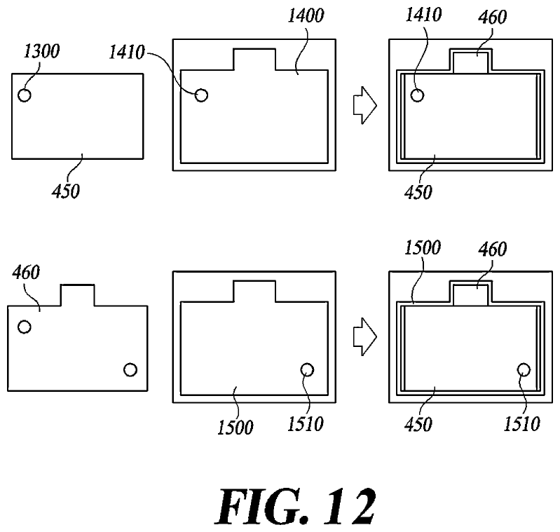

FIG. 12 is a diagram showing a structure to prevent incorrect assembly of the funnel reflector 450 coupled to the one-mirror type head-up display and the two-mirror type head-up display.

Referring to FIG. 12, when the funnel reflector 450 is coupled to the one-mirror type head-up display apparatus 100 and the two-mirror type head-up display apparatus 500, it is coupled in a normal or reverse direction depending on the angle of the liquid crystal layer 410. Therefore, to prevent misassembly during the assembly process of the picture generating unit 120 and the backlight unit 440, the funnel reflector 450 may include a misassembly prevention hole 1300. The misassembly prevention hole 1300 may be formed in one edge of a bottom portion of the funnel reflector 450.

For example, when the funnel reflector 450 and the LED PCB 460 are coupled to the one-mirror type head-up display apparatus 100, the funnel reflector 450 is coupled to the LED PCB 460 in the normal direction. Accordingly, the funnel reflector 450 is coupled with a normal direction boss 1410 on a normal direction jig 1400. The position of the normal direction boss 1410 corresponds to the position of the misassembly prevention hole 1300 when the funnel reflector 450 is coupled in the normal direction.

When the funnel reflector 450 and the LED PCB 460 are coupled to the two-mirror type head-up display apparatus 500, the funnel reflector 450 is coupled to the LED PCB 460 in the reverse direction, that is, by being rotated 180° based on the above-described normal direction. Accordingly, the funnel reflector 450 is coupled with a reverse direction boss 1510 on a reverse direction jig 1500. In this case, the reverse direction boss 1510 is formed at the opposite edge of the jig with respect to the normal direction boss 1410. Accordingly, the misassembly prevention hole 1300 is coupled to the reverse direction boss 1510, and the funnel reflector 450 is coupled in a rotated state of 180°. In this case, the LED PCB 460 includes two holes (not shown) corresponding to the positions of the forward direction boss 1410 and the reverse direction boss 1510.

Therefore, misassembly of the funnel reflector 450 can be prevented by utilizing the anti-misassembly hole 1300 that is coupled to the forward direction boss 1410 or the reverse direction boss 1510 according to the one-mirror type head-up display apparatus 100 and the two-mirror type head-up display apparatus 500.

Various components may be identified differently. For example, the picture generating unit 120 may be identified as a picture generator, the backlight unit 440 may be identified as a backlight, and the fixing unit 490 may be identified as a fixing portion.

The head-up display apparatus according to various aspect of the present disclosure may be explained by following:

According to one aspect, the head-up display apparatus may be comprised: a lower case disposed at a lower portion of the head-up display apparatus; a screen coupled to the lower case and configured to have a light path formed therein; and a picture generating unit coupled to a side wall or a bottom portion of the lower case, wherein the picture generating unit includes: a backlight unit configured to generate light; a diffuser uniformly dispersing light generated from the backlight unit; and a liquid crystal layer configured to selectively transmit light based on magnitude of voltage applied thereto, wherein when the head-up-display apparatus is configured to have one mirror, the picture generating unit is coupled to the side wall of the lower case, and when the head-up-display apparatus is configured to have at least two mirrors, the picture generating unit is coupled to the bottom portion of the lower case.

According to some aspect, the backlight unit may include: an LED PCB including a plurality of light sources; a funnel reflector configured to concentrate light emitted from the LED PCB toward the liquid crystal layer; and a heat sink including an accommodation portion accommodating the funnel reflector and the LED PCB, and a flange portion coupled to the lower case.

According to some aspect, the screen may include a liquid crystal layer mounting portion on which the liquid crystal layer is mounted, and wherein the liquid crystal layer mounting portion is formed based on a predetermined angle formed on the side wall or bottom portion of the lower case.

According to some aspect, the lower case may include a liquid crystal layer mounting portion on which the liquid crystal layer is mounted, and wherein the liquid crystal layer mounting portion is formed based on a predetermined angle formed on the side wall or bottom portion of the lower case.

According to some aspect, the flange portion may have a symmetrical shape.

According to some aspect, the flange portion may include: at least one first locator configured to form a surface protruded by a predetermined height in a z-axis direction on the flange portion and to constrain linear movement of the picture generating unit in at least one direction; a second locator configured to constrain linear movement of the picture generating unit in at least four directions; and a third locator configured to constrain linear movement of the picture generating unit in at least two directions.

According to some aspect, the liquid crystal layer may be configured to mount on the liquid crystal layer mounting portion by: snap-fitting the liquid crystal layer to the liquid crystal layer mounting portion; and snap-fitting the diffuser to the liquid crystal layer mounting portion; and fixing between the diffuser and the liquid crystal layer using an adhesive.

According to some aspect, the liquid crystal layer may be configured to mount on the liquid crystal layer mounting portion by: fixing between the diffuser and the liquid crystal layer using an adhesive; and snap-fitting the diffuser and the liquid crystal layer to the liquid crystal layer mounting portion.

According to some aspect, the liquid crystal layer may be configured to mount on the liquid crystal layer mounting portion by: snap-fitting the liquid crystal layer to the liquid crystal layer mounting portion; snap-fitting the diffuser to the liquid crystal layer mounting portion; and fixing the liquid crystal layer and the diffuser to the liquid crystal layer mounting portion using at least one fixing unit configured to penetrate at least a portion of the liquid crystal layer, the diffuser, and the liquid crystal layer mounting portion.

According to some aspect, the liquid crystal layer is configured to mount on the liquid crystal layer mounting portion by: snap-fitting the liquid crystal layer to the liquid crystal layer mounting portion; snap-fitting the diffuser to the liquid crystal layer mounting portion; and fixing the liquid crystal layer and the diffuser to the liquid crystal layer mounting portion using at least one fixing unit protruding from the liquid crystal layer mounting portion.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A head-up display apparatus comprising:
a lower case disposed at a lower portion of the head-up display apparatus;
a screen coupled to the lower case and configured to include a light path formed therein; and
a picture generator coupled to a side wall or a bottom portion of the lower case,
wherein the picture generator includes:
a backlight configured to generate light;
a diffuser uniformly to disperse light generated from the backlight; and
a liquid crystal layer configured to selectively transmit light based on a magnitude of voltage applied thereto,
wherein, when the head-up-display apparatus is configured to include one mirror, the picture generator is coupled to the side wall of the lower case, and
wherein, when the head-up-display apparatus is configured to include at least two mirrors, the picture generator is coupled to the bottom portion of the lower case.

2. The head-up display apparatus of claim 1, wherein the backlight includes:
a light emitting diode printed circuit board (LED PCB) including a plurality of light sources;
a funnel reflector configured to concentrate light emitted from the LED PCB toward the liquid crystal layer; and
a heat sink including an accommodation portion accommodating the funnel reflector and the LED PCB, and a flange portion coupled to the lower case.

3. The head-up display apparatus of claim 2,
wherein the screen includes a liquid crystal layer mounting portion on which the liquid crystal layer is mounted, and
wherein the liquid crystal layer mounting portion is formed based on a predetermined angle formed on the side wall or bottom portion of the lower case.

4. The head-up display apparatus of claim 2,
wherein the lower case includes a liquid crystal layer mounting portion on which the liquid crystal layer is mounted, and
wherein the liquid crystal layer mounting portion is formed based on a predetermined angle formed on the side wall or bottom portion of the lower case.

5. The head-up display apparatus of claim 2, wherein the flange portion has a symmetrical shape.

6. The head-up display apparatus of claim 3, wherein the flange portion includes:
at least one first locator configured to form a surface protruded by a predetermined height in a z-axis direction on the flange portion and constrain linear movement of the picture generating unit in at least one direction;
a second locator configured to constrain linear movement of the picture generating unit in at least four directions; and
a third locator configured to constrain linear movement of the picture generating unit in at least two directions.

7. The head-up display apparatus of claim 3, wherein the liquid crystal layer is configured to mount on the liquid crystal layer mounting portion by:
snap-fitting the liquid crystal layer to the liquid crystal layer mounting portion; and
snap-fitting the diffuser to the liquid crystal layer mounting portion; and
fixing between the diffuser and the liquid crystal layer using an adhesive.

8. The head-up display apparatus of claim 3, wherein the liquid crystal layer is configured to mount on the liquid crystal layer mounting portion by:
fixing between the diffuser and the liquid crystal layer using an adhesive; and
snap-fitting the diffuser and the liquid crystal layer to the liquid crystal layer mounting portion.

9. The head-up display apparatus of claim 3, wherein the liquid crystal layer is configured to mount on the liquid crystal layer mounting portion by:
snap-fitting the liquid crystal layer to the liquid crystal layer mounting portion;
snap-fitting the diffuser to the liquid crystal layer mounting portion; and
fixing the liquid crystal layer and the diffuser to the liquid crystal layer mounting portion using at least one fixing component configured to penetrate at least a portion of the liquid crystal layer, the diffuser, and the liquid crystal layer mounting portion.

10. The head-up display apparatus of claim 3, wherein the liquid crystal layer is configured to mount on the liquid crystal layer mounting portion by:
snap-fitting the liquid crystal layer to the liquid crystal layer mounting portion;
snap-fitting the diffuser to the liquid crystal layer mounting portion; and
fixing the liquid crystal layer and the diffuser to the liquid crystal layer mounting portion using at least one fixing portion protruding from the liquid crystal layer mounting portion.

11. A head-up display apparatus for a vehicle, comprising:
a lower case disposed at a lower portion of the head-up display apparatus;
a screen coupled to the lower case and including a light path formed therein;
a picture generator including a liquid crystal layer;
a processor configured to control the liquid crystal layer to selectively transmit light, based on a magnitude of voltage applied to the liquid crystal layer,
an aspherical mirror configured to reflect an image including driving information of the vehicle generated by the picture generator to be displayed on a windshield of the vehicle,
wherein the head-up display is configured to accommodate a folding mirror disposed in the light path for modification of the head-up display to a two-mirror type head-up display,
wherein, in case the head-up-display apparatus is configured to include one mirror, the picture generator is coupled to the side wall of the lower case, and
wherein, in case the head-up-display apparatus is configured to include at least two mirrors, the picture generator is coupled to the bottom portion of the lower case.

12. The head-up display apparatus of claim 11, wherein the picture generator further includes:
a backlight configured to generate light; and
a diffuser uniformly to disperse light generated from the backlight.

13. The head-up display apparatus of claim 11, wherein the processor is further configured to control movement of the folding mirror to a position where an image generated by the picture generator is reflected by the folding mirror and projected toward the aspherical mirror.
